(19) United States
(12) Patent Application Publication
(10) Pub. No.: US 2009/0105067 A1
(43) Pub. Date: Apr. 23, 2009

(54) Process for Obtaining Aqueous Suspensions for Electrodes of Solid Oxide Fuel Cells and Other Electrocatalytic Devices

(76) Inventors: Paulo Emilio Valadao De Miranda, Barra da Tijuca (BR); Pedro Ricchini Villa Lobos, Jardim Guanabara (BR)

Correspondence Address: FILDES & OUTLAND, P.C., 20916 MACK AVENUE, SUITE 2, GROSSE POINTE WOODS, MI, 48236, US

(21) Appl. No.: 12/223,956

(22) PCT Filed: Mar. 15, 2007
(86) PCT No.: PCT/BR2007/000063

§ 371 Date: Aug. 13, 2008

(30) Foreign Application Priority Data
Mar. 17, 2006 (BR) P10601210-8

(51) Int. Cl. B01J 31/00; H01M 4/88

(52) U.S. Cl. 502/101; 502/150

(57) ABSTRACT

The innovation here proposed describes a process for obtaining preferentially aqueous suspensions to produce core-shell type (nano) composites of hydrophilic polymers and their application to fabricate suspensions with high content of solids to generate electrodes for solid state electrocatalytic devices (such as solid oxide fuel cells, oxide membrane reactors and other electrocatalytic devices) and/or surface modified electrodes, through the insertion of metallic ions in the hydration water of these (nano) composites in a previous step to that of the ceramic processing (calcination and sintering).

### TECHNICAL FIELD

The present invention describes a process for obtaining aqueous suspensions for the manufacture of porous electrodes for solid oxide fuels cells and other electrocatalytic devices using as principle the generation of core-shell type (nano) composites of hydrophilic polymers and oxide particles processed mechanically (high energy milling), and subsequent hydration of the hydrophilic layer originating stable suspensions with high content of solids.

### TECHNICAL BACKGROUND

The area of solid oxides fuels cells and other electrocatalytic devices presents a variety of suspensions formulations to create films with electrocatalytic activity (electrodes). Such suspensions are applied using several methods, subsequently dried with the formation of a precursor film and, at the final processing step, calcinated (thermally treated) to the organic components and partial linking (sintering) of the particles in a porous film pattern of the electrocatalytic element of interest.

These suspensions are constituted by an organic solvent (usually taxol or terpineol) and addition of compatible polymers (hydrophobic due to the solvent nature) with coadjuvant functions to increase the integrity of the formed precursor film.

In this usual processing, there is the need of using exhausting equipments aiming to the solvent remotion from the environment and are observed the associated risks due to the handling of the organic solvents, such as the risk of explosions and chronic exposition of the operator to the toxicity of the volatiles used.

A search for patent documentation on the subject matter has not indicated the existence of relevant or conflicting documents. However, it is necessary to cite two articles of the open literature that are important to the field analysis in the following.

Pramanik et al. (Jagadish C. Ray, Ranjan K. Pati, P. Parmanik, Journal of the European Ceramic Society 20 (2000), p. 1289-1295) discuss the formation of zirconia nanoparticles stabilized with yttria from the drying of PVA (polyvinyl alcohol), saccharose, and zirconia/yttria nitrate, followed by thermal decomposition of the mass at a temperature of 200 degrees centigrade, milling and calcination. Clear differences of this article in relation to the present patent application are related to the facts that, primarily, the work of Pramanik et al. has as objective to obtain isolated nanoparticles via a wet route (gel), and presents the difficulty of processing (milling) of the resulting mass of the gel decomposition, including with the potential of violent combustion or even explosion, due to the polymer reaction with the nitrate ions under heating in a step previous to the milling operation.

C. Pagliuca et al. (G. Dell'Agli, S. Esposito, G. Mascolo, M. C. Mascolo, C. Pagliuca, Journal of the European Ceramic Society 2.5 (2005), p. 2017-2021), present the use of PVA/PEG (polyethyleneglycol) to the formation of aqueous suspensions of oxides. However, this processing is already performed with the polymer in aqueous medium, being the suspension viscous form. Such processing format differs substantially from the route herein claimed and does not lead to the advantages described in a two stages processing.

### SUMMARY OF THE INVENTION

The present patent describes preferential methods and materials for obtaining core-shell type (nano) composites of hydrophilic polymers and their application to obtain suspensions with high content of solids which generate electrodes for solid state electrocatalytic devices (such as solid oxide fuel cells, oxide membrane reactors and others electrocatalytic devices) and/or surface modified electrodes through the insertion of metallic ions in the hydration water of these (nano) composites in a previous step to the ceramic processing (calcination and sintering).

### DETAILED DESCRIPTION OF THE INVENTION

The invention herein described take into consideration the difference of hardness of two or more constituents of a mixture for electrodes processing, on the one hand constituted with inorganic solids such as yttria stabilized zirconia, cerium oxide, gadolinium doped cerium oxide with, nickel oxide, copper oxide among others with properties of interest to the functioning of the device, catalysts and/or solid electrodes, and on the other hand with organic additions, preferentially polyethyleneglycol and/or polyvinyl alcohol and/or saccharose, among others.

The process consists to submit the organic components above described to dry milling in a planetary ball mill (relation between the mass of material to be processed and mass of the grinding balls ranging from 1:2 to 1:8, preferentially 1:3 to 1:6, typical occupation between 40 to 80% of the milling vessel volume) in consecutive millings, typically between 2 to 12 cycles, preferentially between 6 to 10 cycles, up to 10 minutes each, with rotation between 100 to 300 rpm, aiming to obtain a material finely divided and homogeneous. This first step has as objective diminishing the size of the organic phase particle and homogenizing it, and therefore, it is applied only to the case of multiples organic components or in the case of organic components of very high granulometry compared to that of the inorganic components. For cases where there is granulometry similarity between the organic and inorganic phases, one can go on directly to the step described in the following.

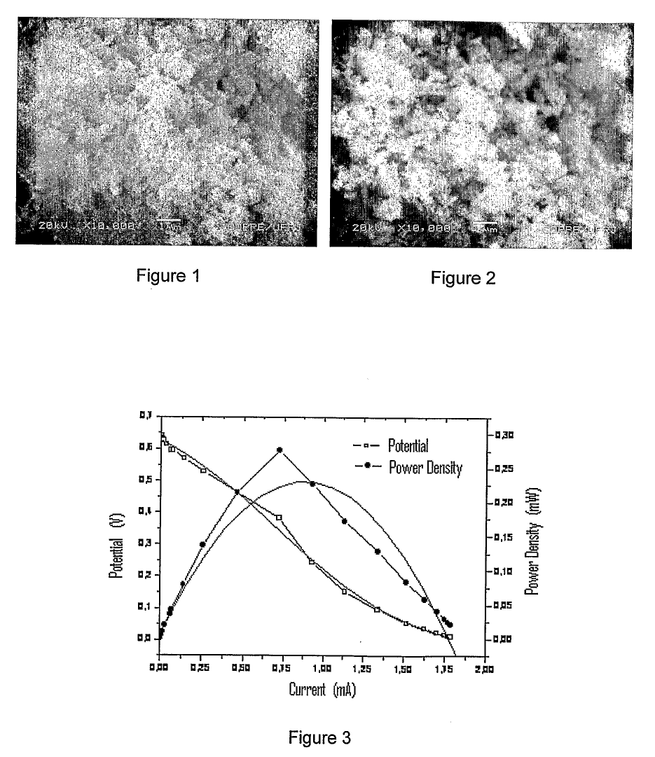

The resulting material of the above procedure is submitted to a new processing in a planetary ball mill with the inorganic components of the mixture, in the same condition ranges described above, but with an amount of 0.01 to 15%, preferentially between 0.01 to 5%, more preferentially between 0.01 to 2% by mass of the organic fraction with respect to the active inorganic component. The resulting mass is constituted of the (nano) composite illustrated in FIGS. 1 and 2.

The resulting mass is processed in a suspension by the addition of water and mechanical homogenization in an adequate amount to the desired viscosity according to the subsequent deposition process, which is not object of this patent.

In an alternative manner, it is possible the insertion of inorganic ions, preferentially nitrates, of chemical elements of which there is the interest in the formation of a surface layer of copper oxide on the one originally added in the milling step. In this case, the inorganic ions, preferentially zirconia, yttrium, cerium, gadolinium, nickel and copper nitrates, among others, are added in the hydration water, originating the modified suspension resulting from the mechanical homogenization. The desired viscosity of the suspension is a function of the amount of aqueous solution or added water and, as in the previous example, it depends on the subsequent deposition procedure, which is not object of this patent.

The ions insertion in the hydration solution can lead to the generation of auxiliary structures of sintering, to the formation of new surface oxide layer capable of modifying the electrocatalytic properties of the film at the end of the process (when compared to the film obtained in the processing without the salts), among others process that can result in the improvement of the desired properties.

The utilization of two processing steps, the first one consisting of dry milling and the second one with solvent addition (water), also leads to a storage advantage in which the precursor mixture of the suspension can be maintained for long time periods (estimated in time of years).

The processing of mixtures of the above described nature in high energy equipments—such as the planetary ball mill, in the conditions described and detailed in the following example, leads to the formation of a polymeric layer that covers the individual particles of the inorganic components—FIGS. 1 and 2, which in a subsequent hydration leads to the formation of pastes with high content of dispersed solids.

An additional function of this layer is the stabilization of the as formed surfaces that result from breaking the inorganic particles by milling, when these particles are with size in the range of microns or greater sizes, stabilizing the particles possess a size usually of interest to the application, sub-micrometric size and/or contributing to the formation of a fraction of particles of small size which can improve the sintering properties. In other words, this processing can also start from powders with particle size relatively big, cheaper than powders possessing particles in a sub-micrometric scale.

This polymeric layer avoids the particle agglomeration, and the generated structure is kept stable for long periods of time (comparable with the stability of the dry polymer), resulting in a product with long shelf life. In other words, it constitutes a precursor mixture to the generation of the suspension, without the problems of colloid stability.

FIGS. 1 and 2 show the formation of these (nano) composites through the comparison between the images of secondary electrons (real topography—FIG. 1) and retro-scattered (inorganic fraction of high molecular mass—FIG. 2).

Upon effectively being used, this material is added to the appropriated polar solvent, preferentially water, which results in hydration and partial solubilization of the surface polymeric layer and consequent formation of a suspension with high content of solids. These are sterically stabilized by the polymeric chains adjacent to the inorganic particles surfaces and by the high viscosity of the medium itself. Such suspensions are then deposited on the substrates and receive the thermal treatments adequate to produce electrodes for solid oxides fuel cells, for oxide membrane reactors and for other electrocatalytic devices.

### EXAMPLES

Obtaining modified electrodes with the addition of precursors of yttria stabilized zirconia with the objective of improving its micro-structure.

Polyvinyl alcohol (PVA) and saccharose (in a proportion ranging from 0 to 15% by weight) are previously milled/homogenized in a planetary ball mill (relation between the mass of material to be processed and the mass of the milling balls ranging from 1:2 to 1:8, typical occupation from 40 to 80% of the milling vessel volume) in consecutives millings, typically 9 cycles of 10 minutes each, with rotation between 100 and 300 rpm.

The resulting material of the above procedure is milled once again, in the same conditions described above, however with a content ranging from 0.1 to 15% by mass with respect to the active ceramic component, herein taken as cermet composed of nickel oxide and yttria stabilized zirconia, using in this case commercial product with 70% by weight of nickel oxide. The resulting mass is constituted of (nano) composite illustrated in FIGS. 1 and 2.

The resulting precursor mixture was hydrated with an acid solution of zirconium IV and yttrium III nitrates, in a proportion adequate to form 8% mol yttria stabilized zirconia (8YSZ) during the suspension burning process addition of solution aiming to obtain 0.001 to 10% by mass of yttria stabilized zirconia with respect to the content of the solid cermet.

The viscosity of the final mass can still be better adjusted with the addition of deionized water, resulting in the formation of a paste with a viscosity adequate to the formation of a film on an electrolyte of 8YSZ.

The film so obtained film can be processed in a porous electrode through an adequate ceramic processing, being demonstrated below the improvement in the performance of this film with respect to the control material ((nano) composite hydrated only with deionized water).

FIG. 3 shows curves of difference of potential and of power density versus current for the control material—cermet processed only with polyvinyl alcohol and deionized water, with the conditions described above.

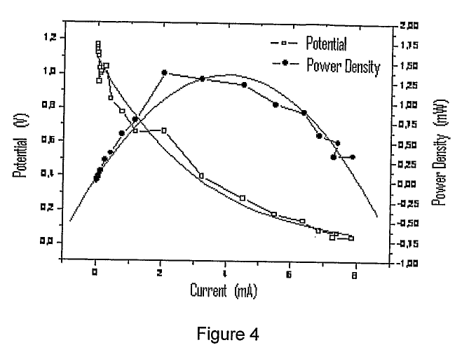

FIG. 4 shows curves of difference of potential and of power density versus current for the material processed as indicated in the example above, presenting a five fold increase in power density.

1. Process for obtaining aqueous suspensions for electrodes of solid oxide fuel cells and other electrocatalytic devices, characterized by dry milling of organic components in a planetary ball mill with relation between the mass of material to be processed and the mass of the milling balls ranging from 1:2 to 1:8, preferentially 1:3 to 1:6, with typical occupation of the milling vessel volume from 40 to 80% and consecutive millings, typically from 2 to 12 cycles, preferentially from 6 to 10 cycles, of up to 20 minutes each, with rotation from 100 to 300 rpm, also followed also by processing on planetary ball mill with the addition of a mixture of organic components in the same condition described above, but with a content varying from 0.01 to 15%, preferentially from 0.01 to 5%, yet more preferentially from 0.01 to 2% by mass of the organic fraction with respect to the active inorganic component, the resulting mass being processed in a suspension by water addition and by mechanical homogenization in adequate amounts to the desired viscosity according to a subsequent deposition process.

2. Process adequate to the situation in which the organic phase is already finely divided, characterized by a single dry milling of the organic and inorganic components in a planetary ball mill with relation between the mass of the material to be processed and the mass of the milling balls ranging from 1:2 to 1:8, preferentially 1:3 to 1:6, with typical occupation of the milling vessel volume from 40 to 80% and consecutive millings, typically from 2 to 12 cycles, preferentially from 6 to 10 cycles, of up to 20 minutes each, with rotation from 100 to 300 rpm, and a content varying from 0.01 to 15%, preferentially from 0.01 to 5%, yet more preferentially from 0.01 to 2% by mass of the organic fraction with respect to the active organic component, the resulting mass being processed in a suspension by water addition and by mechanical homogenization in adequate amounts to the desired viscosity according to a subsequent deposition process.

3. Process adequate to the situation in which the inorganic phase has a particle size relatively large, superior to the desired one in the final suspension, characterized by a single dry milling of the organic and inorganic components in a planetary ball mill with relation between the mass of material to be processed and the mass of the milling balls in the range from 1:2 to 1:8, preferentially from 1:3 to 1:6, with typical occupation of the milling vessel volume from 40 to 80% and consecutive millings, typically from 2 to 12 cycles, preferentially from 6 to 10 cycles, of up to 20 minutes each, with rotation from 100 to 300 rpm, and a content from 0.01 to 15%, preferentially from 0.01 to 5%, yet more preferentially from 0.01 to 2% by mass of the organic fraction with respect to the active organic component, the resulting mass being processed in a suspension by water addition and by mechanical homogenization in adequate amounts to the desired viscosity according to a subsequent deposition process.

4. Process according to claim 1, characterized by the preferential utilization of organic components such as polyethyleneglycol, polyvinyl alcohol and saccharose, among others.

5. Process according to claim 2, characterized by the preferential utilization of inorganic components such as yttria stabilized zirconia, gadolinium doped ceria, nickel oxide, copper oxide, among others.

6. Process according to claim 1, characterized by the substitution of water by solution of inorganic ions.

7. Process according to claim 6, characterized by the preferential utilization of inorganic ions nitrates, such as zirconium, yttrium, gadolinium, nickel, copper, among others.

8. Process according to claim 1, characterized by the obtaining core-shell type nano-composites of hydrophilic polymers-inorganic oxides.

9. Process according to claim 1, characterized by obtaining an adequate suspension for the formation of porous heterogeneous structures of inorganic skeleton coated with oxides.

10. Suspension according to what was described in claim 1, characterized by its use to fabricate solid oxide fuel cells, oxide membrane reactors, and other electrocatalytic devices.

11. Process according to claim 2 characterized by the preferential utilization of organic components such as polyethyleneglycol, polyvinyl alcohol and saccharose, among others.

12. Process according to claim 3 characterized by the preferential utilization of inorganic components such as yttria stabilized zirconia, gadolinium doped ceria, nickel oxide, copper oxide, among others.

13. Process according to claim 2 characterized by the substitution of water by solution of inorganic ions.

14. Process according to claim 3 characterized by the substitution of water by solution of inorganic ions.

15. Process according to claim 2 characterized by the obtaining core-shell type nano-composites of hydrophilic polymers-inorganic oxides.

16. Process according to claim 3 characterized by the obtaining core-shell type nano-composites of hydrophilic polymers-inorganic oxides.

17. Process according to claim 2 characterized by obtaining an adequate suspension for the formation of porous heterogeneous structures of inorganic skeleton coated with oxides.

18. Process according to claim 3 characterized by obtaining an adequate suspension for the formation of porous heterogeneous structures of inorganic skeleton coated with oxides.

19. Suspension according to claim 2 characterized by its use to fabricate solid oxide fuel cells, oxide membrane reactors, and other electrocatalytic devices.

20. Suspension according to claim 3 characterized by its use to fabricate solid oxide fuel cells, oxide membrane reactors, and other electrocatalytic devices.
